(19) United States
(12) Patent Application Publication
(10) Pub. No.: US 2026/0184190 A1
(43) Pub. Date: Jul. 2, 2026

(54) ELECTRIC VEHICLE AND POWER RECEIVING UNIT

(71) Applicant: TOYOTA JIDOSHA KABUSHIKI KAISHA, Toyota-shi Aichi-ken (JP)

(72) Inventors: Daisuke UEO, Nagoya-shi Aichi-ken (JP); Kenta WATANABE, Toyota-shi Aichi-ken (JP)

(73) Assignee: TOYOTA JIDOSHA KABUSHIKI KAISHA, Toyota-shi Aichi-ken (JP)

(21) Appl. No.: 19/429,081

(22) Filed: Dec. 22, 2025

(30) Foreign Application Priority Data
Dec. 27, 2024 (JP) 2024-232306

(51) Int. Cl. B60L 15/20; B60L 53/12; B60L 53/16; E05B 83/28

(52) U.S. Cl. CPC B60L 15/20; B60L 53/12; B60L 53/16; E05B 83/28

(57) ABSTRACT

An electric vehicle includes a power receiving unit, a charging inlet to which a station connector of a charging station is connectable, a battery configured to be charged with electric power supplied from the charging inlet, a lid configured to open and close the charging inlet, a lock portion configured to lock the lid in a closed state, a connection sensor, a lock sensor, and a control device

### CROSS-REFERENCE TO RELATED APPLICATION

This application is based upon and claims the benefit of priority of the prior Japanese Patent Application No. 2024-232306, filed on Dec. 27, 2024, the entire contents of which are incorporated herein by reference.

### TECHNICAL FIELD

The present disclosure relates to an electric vehicle and a power receiving unit.

### BACKGROUND

A battery of an electric vehicle is charged by connecting a station connector of a charging station to a charging inlet of the electric vehicle that is stopped (for example, see Japanese Unexamined Patent Application Publication No. 2022-039337).

It is desired to achieve power charging during traveling in which electric power is supplied to the electric vehicle during traveling to charge a battery. It takes time to spread such an electric vehicle capable of achieving power charging during traveling. Therefore, it is conceivable to attach a power receiving unit for achieving power charging during traveling to a conventional electric vehicle that is capable of being charged only during stopping. However, if the configuration of the conventional electric vehicle is largely changed in order to achieve the power charging during traveling, the cost might increase.

### SUMMARY

It is therefore an object of the present disclosure to provide an electric vehicle and a power receiving unit achieving power charging during traveling at low cost.

The above object is achieved by an electric vehicle including: a power receiving unit; a charging inlet to which a station connector of a charging station is connectable; a battery configured to be charged with electric power supplied from the charging inlet; a lid configured to open and close the charging inlet; a lock portion configured to lock the lid in a closed state; a connection sensor; a lock sensor; and a control device, wherein the power receiving unit is configured to include: a power receiving portion configured to receive electric power transmitted from outside the electric vehicle; and a unit cable configured to transmit electric power from the power receiving portion to the charging inlet, the unit cable includes: a unit connector connectable to the charging inlet; and a unit locked portion locked by the lock portion when the unit connector is connected to the charging inlet, the connection sensor detects a connected state in which one of the station connector and the unit connector is connected to the charging inlet, the lock sensor detects a locked state in which one of the lid and the unit locked portion is locked by the lock portion, and the control device is configured to permit charging of the battery while not permitting traveling of the electric vehicle when the connected state is made and the locked state is not made, and is configured to permit charging of the battery while permitting traveling of the electric vehicle when the connected state and the locked state are made.

The power receiving portion may be attached to a bottom surface of the electric vehicle and may receive electric power from a non-contact charging system in a non-contact manner.

The power receiving portion may be attached to an upper surface of the electric vehicle and may receive electric power by contacting a contact-type charging system.

Also, the above object is achieved by a power receiving unit attachable to an electric vehicle, wherein the electric vehicle includes: a charging inlet to which a station connector of a charging station is connectable; a battery configured to be charged with electric power supplied from the charging inlet; a lid configured to open and close the charging inlet; a lock portion configured to lock the lid in a closed state; a connection sensor; a lock sensor; and a control device, the power receiving unit is configured to include: a power receiving portion configured to receive electric power transmitted from outside the electric vehicle; and a unit cable configured to transmit electric power from the power receiving portion to the charging inlet, the unit cable includes: a unit connector connectable to the charging inlet; and a unit locked portion locked by the lock portion when the unit connector is connected to the charging inlet; and the connection sensor detects a connection state in which one of the station connector and the unit connector is connected to the charging inlet, the lock sensor detects a locked state in which one of the lid and the unit locked portion is locked by the lock portion, and the control device is configured to permit charging of the battery while not permitting traveling of the electric vehicle when the connected state is made and the locked state is not made, and is configured to permit charging of the battery while permitting traveling of the electric vehicle when the connected state and the locked state are made.

### BRIEF DESCRIPTION OF THE DRAWINGS

FIG. 1 is a schematic configuration view of an electric vehicle;

FIG. 2 is an explanatory view of charging of a battery of the electric vehicle by a charging station;

FIG. 3 is an explanatory view of a power receiving unit attached to the electric vehicle;

FIG. 4 is an explanatory view of power charging during traveling by the power receiving unit;

FIG. 5 is a flowchart illustrating an example of charging control executed by an ECU; and

FIG. 6 is an explanatory view of a power receiving unit of a modification attached to the electric vehicle.

### DETAILED DESCRIPTION

### Schematic Configuration of Electric Vehicle

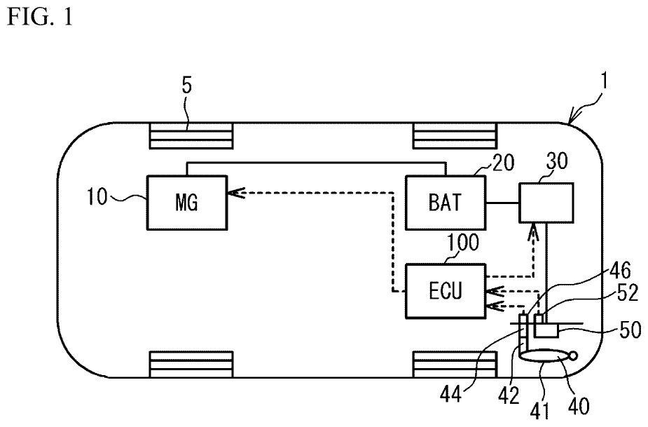

FIG. 1 is a schematic configuration view of an electric vehicle 1. The electric vehicle 1 includes a motor 10, a battery 20, a charging device 30, a lid 40, a charging inlet 50, and an electronic control unit (ECU) 100. The motor 10 is a traveling power source of the electric vehicle 1. The power of the motor 10 is transmitted to drive wheels 5 via, for example, an automatic transmission. The DC power of the battery 20 is converted into an AC current and supplied to the motor 10, whereby the motor 10 is driven. The charging device 30 is controlled by the ECU 100, and converts AC power from an external power source into DC current to charge the battery 20 when a predetermined condition is satisfied.

The charging inlet 50 is configured to be selectively connected to a station connector 206 and a unit connector 116, which will be described later. A connection sensor 52 detects a connected state in which either the station connector 206 or the unit connector 116 is connected to the charging inlet 50.

The lid 40 is attached to an opening 41 of the electric vehicle 1 by, for example, a hinge mechanism so as to be able to open and close the opening 41. The lid 40 opens the opening 41, so that the charging inlet 50 is accessible from the outside. A lid locked portion 42 is attached to the back surface of the lid 40. A lock portion 44 engages with the lid locked portion 42 in a state where the lid 40 is closed. Thus, the lock portion 44 locks the lid 40 in the closed state. The lock portion 44 is provided in the vicinity of the charging inlet 50. A lock sensor 46 detects the above-described locked state.

The ECU 100 includes a processing circuit that performs various processes related to the travel control of the electric vehicle 1. The ECU 100 is an example of a control device. The ECU 100 controls the driving of the motor 10 and controls the charging state of the battery 20. The ECU 100 is electrically connected to the lock sensor 46 and the connection sensor 52. The ECU 100 determines permission or non-permission of the traveling of the electric vehicle 1 and permission of the charging of the battery 20 according to the detection results of the lock sensor 46 and the connection sensor 52.

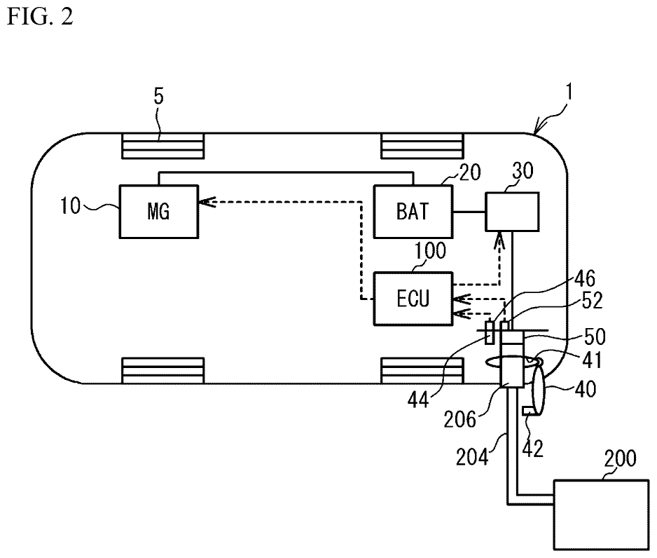

FIG. 2 is an explanatory view of charging of the battery 20 of the electric vehicle 1 by a charging station 200. FIG. 2 illustrates a state where the station connector 206 of the charging station 200 is connected to the charging inlet 50 of the electric vehicle 1 that is stopped. The station connector 206 is attached to the tip of a station cable 204 of the charging station 200. The station connector 206 is connected to the charging inlet 50 in a state where the lid 40 opens the opening 41. Therefore, in the state of FIG. 2, the ECU 100 does not permit the electric vehicle 1 to travel, and controls the charging device 30 to permit the battery 20 to be charged with electric power from the charging station 200, which will be described in detail later. Thus, the battery 20 is charged with electric power from the charging station 200 via the station cable 204, the station connector 206, the charging inlet 50, and the charging device 30.

### Schematic Configuration of Power Receiving Unit

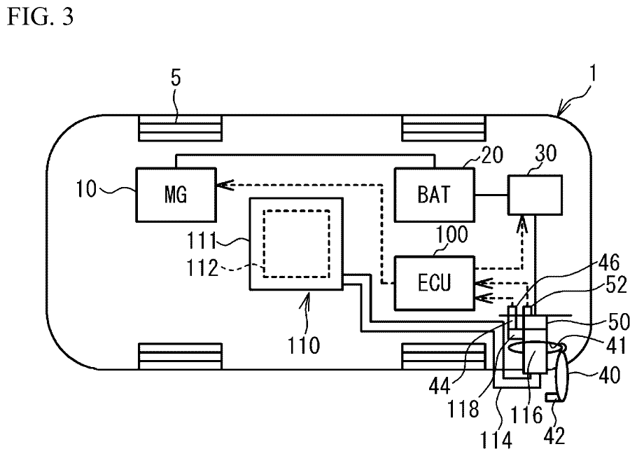

Next, a power receiving unit 110 attached to the electric vehicle 1 will be described. FIG. 3 is an explanatory view of the power receiving unit 110 attached to the electric vehicle 1. The power receiving unit 110 includes a power receiving portion 111, a power receiving coil 112, a unit cable 114, the unit connector 116, and a unit locked portion 118. The power receiving portion 111 has a substantially flat plate shape. The power receiving portion 111 is attached to a bottom surface 3 of the electric vehicle 1 by a fastening member such as a bracket or a bolt. Such an attachment operation is performed, for example, at a dealer. The power receiving coil 112 is provided in the power receiving portion 111. The power receiving portion 111 receives electric power transmitted from the outside of the electric vehicle 1 in a non-contact manner, which will be described in detail later.

The unit cable 114 is attached to the power receiving portion 111. The unit connector 116 is attached to the end of the unit cable 114. The unit locked portion 118 is integrally provided on a side portion of the unit connector 116. The unit locked portion 118 is locked by the lock portion 44 in a state where the unit connector 116 is connected to the charging inlet 50. In the state illustrated in FIG. 3, the ECU 100 permits the electric vehicle 1 to travel and controls the charging device 30 to permit the charging of the battery 20, which will be described in detail later. The unit connector 116 has the same shape and size as the station connector 206.

### Power Charging During Traveling

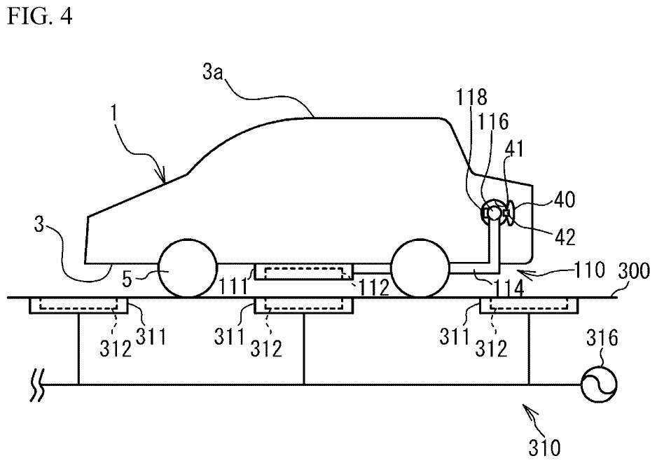

FIG. 4 is an explanatory view of power charging during traveling by the power receiving unit 110. A non-contact charging system 310 is provided under a traveling road surface 300. The non-contact charging system 310 includes a plurality of power transmission portions 311. The plurality of power transmission portions 311 are arranged in the direction in which the traveling road surface 300 extends. The plurality of power transmission portions 311 are connected to an external power supply 316. A power transmission coil 312 is provided in the power transmission portion 311. When the electric vehicle 1 to which the power receiving unit 110 is attached travels on the traveling road surface 300, the power receiving coil 112 is magnetically coupled to the power transmitting coil 312 and receives supply of AC power. The electric power received by the power receiving coil 112 is charged in the battery 20 via the unit cable 114, the charging inlet 50, and the charging device 30. In this way, the power receiving unit 110 receives electric power in a non-contact manner, and the battery 20 is charged.

### Charging Control

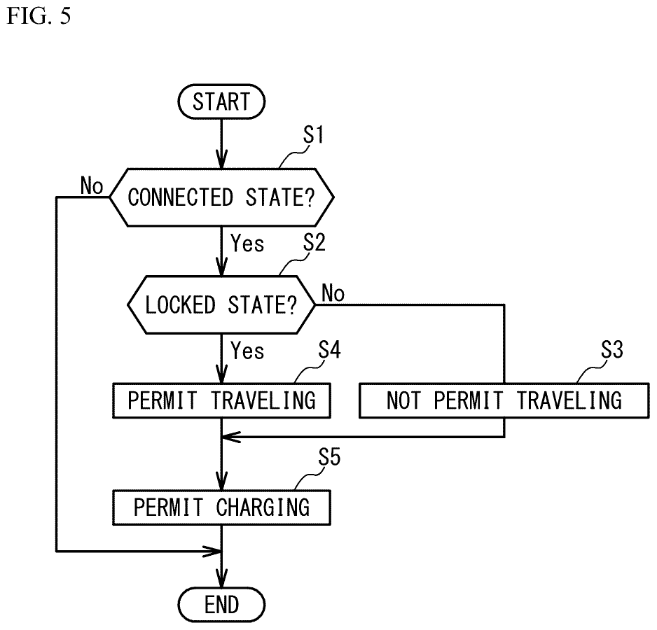

FIG. 5 is a flowchart illustrating an example of charging control performed by the ECU 100. On the basis of the connection sensor 52, the ECU 100 determines whether or not the connected state is made (step S1). If the determination result in step S1 is No, the control is terminated. If the determination result is Yes in step S1, the ECU 100 determines whether or not the locked state is made on the basis of the lock sensor 46 (step S2).

If the determination result is Yes in step S1 and the determination result is No in step S2, it is considered that the station connector 206 is connected to the charging inlet 50 with the lid 40 opened as illustrated in FIG. 2. Therefore, the ECU 100 does not permit the electric vehicle 1 to travel (step S3), and permits the battery 20 to be charged by controlling the charging device 30 (step S5). By prohibiting the traveling of the electric vehicle 1, the electric vehicle 1 is prevented from traveling during the charging of the battery 20 in a state where the station connector 206 is connected to the charging inlet 50. The prohibition of the traveling of the electric vehicle 1 may be achieved by prohibiting the switching to the ready-on state in the ready-off state, or may be achieved by switching to the ready-off state in the ready-on state.

When the determination result is “Yes” in both steps S1 and S2, it is considered that the unit connector 116 is connected to the charging inlet 50 in a state where the lid 40 is opened as illustrated in FIG. 3, and the unit locked portion 118 is locked by the lock portion 44. Therefore, the ECU 100 permits the electric vehicle 1 to travel (step S4), and controls the charging device 30 to permit the charging of the battery 20 (step S5). Thus, the electric vehicle 1 travels on the traveling road surface 300 described above, and thus the power charging during traveling is achieved. The permission of the travel of the electric vehicle 1 is achieved by, for example, switching to the ready-on state in the ready-off state, or by continuing the ready-on state in the ready-on state.

As described above, by attaching the power receiving unit 110 to the electric vehicle 1 which has been already spread, the electric power is supplied during traveling. Thus, electric vehicles capable of achieving power charging during traveling is spread at an early stage. For example, it is conceivable to attach the power receiving portion 111 to the electric vehicle 1 and change the configuration in the electric vehicle 1 so that electric power is directly supplied from the power receiving portion 111 to the charging device 30. However, in this case, it is needed to largely change the configuration of the electric power system in the electric vehicle 1, and the cost might increase. In the present embodiment, by using the conventional charging inlet 50, the power charging during traveling is achieved at low cost without largely changing the configuration of the electric vehicle 1.

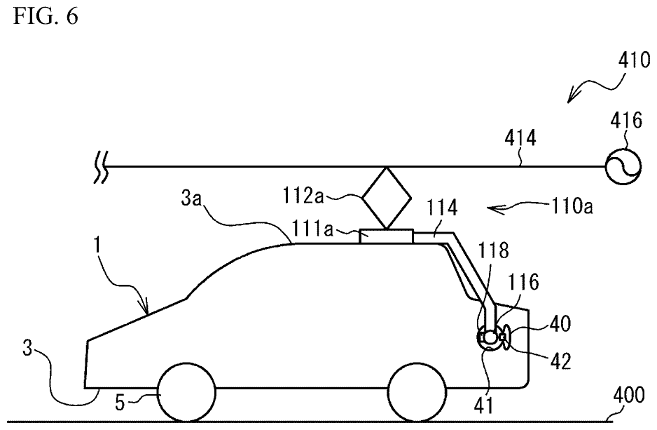

FIG. 6 is an explanatory view of a power receiving unit 110a of a modification attached to the electric vehicle 1. A power receiving portion 111a of the power receiving unit 110a is attached to an upper surface 3a of the electric vehicle 1 by a fastening member such as a bracket or a bolt. A pantographic 112a is provided in the power receiving portion 111a. A contact-type charging system 410 includes an overhead wire 414. The overhead wire 414 is connected to an external power supply 416 and is disposed at a predetermined height position from a traveling road surface 400. When the pantograph 112a is in contact with the overhead wire 414, the pantograph 112a is supplied with an alternating current. The power received by the pantograph 112a is charged to the battery 20 via the unit cable 114, the charging inlet 50, and the charging device 30. Thus, the power receiving portion 111a may be configured to receive power when the pantograph 112a contacts the contact-type charging system 410.

The electric vehicle 1 includes only the motor 10 as a traveling power source, but is not limited thereto. The electric vehicle may be a so-called plug-in hybrid vehicle including an engine in addition to the motor.

Although some embodiments of the present disclosure have been described in detail, the present disclosure is not limited to the specific embodiments but may be varied or changed within the scope of the present disclosure as claimed.

What is claimed is:

1. An electric vehicle comprising:
a power receiving unit;
a charging inlet to which a station connector of a charging station is connectable;
a battery configured to be charged with electric power supplied from the charging inlet;
a lid configured to open and close the charging inlet;
a lock portion configured to lock the lid in a closed state;
a connection sensor;
a lock sensor; and
a control device,
wherein:
the power receiving unit is configured to include:
a power receiving portion configured to receive electric power transmitted from outside the electric vehicle; and
a unit cable configured to transmit electric power from the power receiving portion to the charging inlet,
the unit cable includes:
a unit connector connectable to the charging inlet; and
a unit locked portion locked by the lock portion when the unit connector is connected to the charging inlet,
the connection sensor detects a connected state in which one of the station connector and the unit connector is connected to the charging inlet,
the lock sensor detects a locked state in which one of the lid and the unit locked portion is locked by the lock portion, and
the control device is configured to permit charging of the battery while not permitting traveling of the electric vehicle when the connected state is made and the locked state is not made, and is configured to permit charging of the battery while permitting traveling of the electric vehicle when the connected state and the locked state are made.

2. The electric vehicle according to claim 1, wherein the power receiving portion is attached to a bottom surface of the electric vehicle and receives electric power from a non-contact charging system in a non-contact manner.

3. The electric vehicle according to claim 1, wherein the power receiving portion is attached to an upper surface of the electric vehicle and receives electric power by contacting a contact-type charging system.

4. A power receiving unit attachable to an electric vehicle, wherein
the electric vehicle includes:
a charging inlet to which a station connector of a charging station is connectable;
a battery configured to be charged with electric power supplied from the charging inlet;
a lid configured to open and close the charging inlet;
a lock portion configured to lock the lid in a closed state;
a connection sensor;
a lock sensor; and
a control device,
the power receiving unit is configured to include:
a power receiving portion configured to receive electric power transmitted from outside the electric vehicle; and
a unit cable configured to transmit electric power from the power receiving portion to the charging inlet,
the unit cable includes:
a unit connector connectable to the charging inlet; and a unit locked portion locked by the lock portion when the unit connector is connected to the charging inlet; and
the connection sensor detects a connection state in which one of the station connector and the unit connector is connected to the charging inlet,
the lock sensor detects a locked state in which one of the lid and the unit locked portion is locked by the lock portion, and
the control device is configured to permit charging of the battery while not permitting traveling of the electric vehicle when the connected state is made and the locked state is not made, and is configured to permit charging of the battery while permitting traveling of the electric vehicle when the connected state and the locked state are made.
